(19) United States
(12) Patent Application Publication
(10) Pub. No.: US 2010/0127954 A1
(43) Pub. Date: May 27, 2010

(54) Display Form Factor Devices and Methods Thereof

(75) Inventors: Joonwoo Park, Chicago, IL (US); John A. Burroughs, Lake Zurich, IL (US); Sean N. Davie, Lawrenceville, GA (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, Libertyville, IL (US)

(21) Appl. No.: 12/323,557

(22) Filed: Nov. 26, 2008

(51) Int. Cl. G09G 5/00

(52) U.S. Cl. 345/7

(57) ABSTRACT

Disclosed are display form factor devices having a first orientation and a second orientation, such a device including a display screen that is viewable from a plurality of positions. The display screen can be moved with respect to the first orientation and/or the second orientation. The display screen in accordance with a controller is configured to exhibit indicia having a particular orientation thereon, wherein the indicia having a particular orientation is dependent upon which of the at least one of a plurality of positions that is assumed by the screen body. For example, a particular orientation may be a reflective mode or a normal mode. A method of the device includes changing the particular orientation of the indicia based upon the position of the screen body. Sensed ambient conditions can provide input to determine the position of the screen body.

### FIELD

Disclosed are display form factor devices and methods thereof, and more particularly devices that include a display screen capable of assuming a plurality of positions.

### BACKGROUND

A Heads Up Display (HUD) is an automotive informational display which is typically part of a navigation system. Navigation indicia are often exhibited on its display screen. A HUD can be configured to rest on the dashboard of an automobile. The small size of the device allows it to rest in front of the steering wheel without obstructing the view through the windshield from the driver's seat of the vehicle. Often, a HUD projects navigation information onto a reflective film placed onto the vehicle's windshield. The display in fact exhibits the indicia in reverse, so that when reflected by the film, a viewer can see it in its normal orientation. When reflected off the reflective film placed onto the windshield, the indicia are substantially transparent and therefore do not obstruct the view through the windshield from the driver's seat.

A HUD may include a receiver to receive a signal from another device, and a processor, for example to process navigation data for display. A HUD can project any type of information, such as velocity direction, time, date and the like, onto the display area of a reflective film. The HUD may also include speakers for audio output, so that it can be a wireless intercom device for communication with other systems. A HUD may be, for example, Bluetooth enabled, FM enabled, or may connect manually to a device transmitting the signal. The device transmitting the signal may be a receiving device such as a mobile communication device.

### BRIEF DESCRIPTION OF THE DRAWINGS

FIG. 1 illustrates a perspective view of an embodiment of a display form factor device;

FIG. 2 illustrates a side perspective of an embodiment of a display form factor;

FIG. 3 illustrates a perspective view of an embodiment of a display form factor similar to the view of FIG. 1;

FIG. 4 illustrates a perspective view of an embodiment of a display form factor also similar to the view of FIG. 1;

FIG. 5 illustrates a side perspective of an embodiment of a display form factor;

FIG. 6 illustrates a perspective view of an embodiment of a display form factor similar to the view of FIG. 1;

FIG. 7 illustrates another perspective view of an embodiment of a display form factor;

FIG. 8 illustrates indicia in a reflective mode that is transposed to normal mode upon reflection by a reflective film;

FIG. 9 illustrates a front view of an embodiment of a display form factor device where the screen body has assumed the same position as that shown in FIG. 5;

FIG. 10 illustrates a view of the display screen of an embodiment of a display form factor device in a position such as that shown in FIGS. 2 and 8; and

FIG. 11 illustrates a perspective view of an embodiment of the display form factor device 1100 including electronic components.

### DETAILED DESCRIPTION

It would be beneficial if indicia exhibited the display of a HUD were viewable not only in a reflective film, but directly as well. It would be further beneficial if the display of the HUD could be manipulated so that it may be viewed from many different orientations. It would be further beneficial if the mode of exhibiting indicia were based upon the position of the screen body.

Disclosed are display form factor devices having a first orientation and a second orientation, such a device including a display screen that is viewable from a plurality of positions. The first orientation is for example, a horizontal orientation. The second orientation is for example, a vertical orientation. The display screen can be moved with respect to the first orientation and/or the second orientation. The display screen in accordance with a controller is configured to exhibit indicia having a particular orientation thereon, wherein the indicia having a particular orientation is dependent upon which of a plurality of positions that is assumed by the screen body. For example, a particular orientation may be a reflective mode or a normal mode. A method of the device includes changing the particular orientation of the indicia based upon the position of the screen body. Sensed ambient conditions can provide input to determine the position of the screen body.

A display form factor device includes a base body and a screen body. The base body further has a top portion and a lower portion wherein the screen body is coupled to the base body at the top portion of the base body. A hinge movably couples the screen body to the base body, the hinge being configured to allow pivotal movement of the screen body with respect to the base body along the first orientation. The display form factor further includes a pivot member movably coupled to the lower portion of the base body, the pivot member being configured to allow pivotal movement of the base member along the second orientation. A display screen is supported by the screen body, the screen body being configured to assume a plurality of positions with respect to the base body and the pivot member along the first orientation and the second orientation. Accordingly, in adjusting the position of screen body to one of a plurality of positions, viewing from one particular orientation may be better than viewing from another particular orientation. In this way, beneficially the display device of a display form factor device can be manipulated so that it may be viewed from many different orientations.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

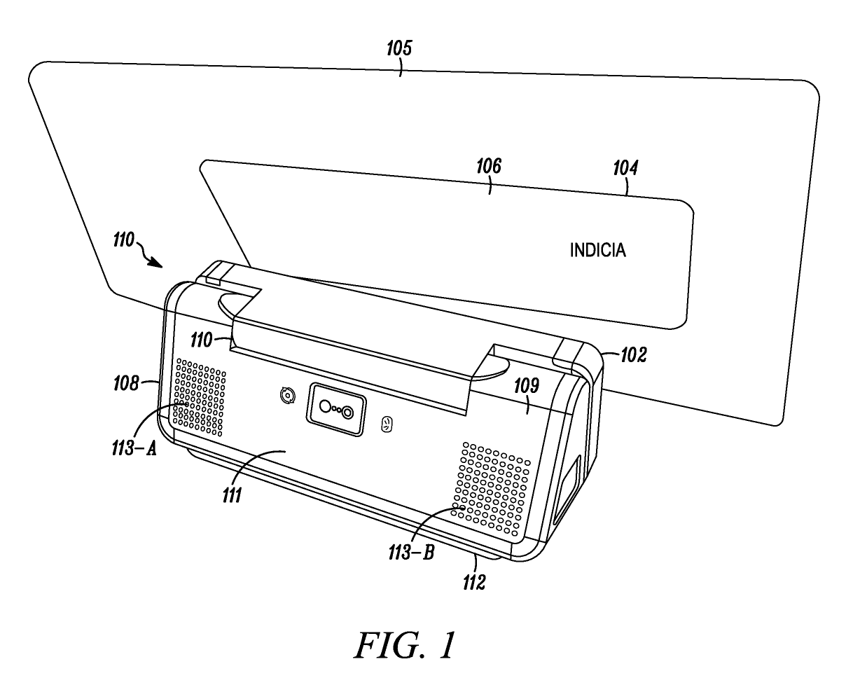

FIG. 1 illustrates a perspective view of an embodiment of a display form factor device 100. The display screen (not shown in FIG. 1) which is supported by the screen body 102, is facing a reflective member 104. The reflective member 104 may be supported, for example, by a windscreen 105 of a vehicle and may be attachable to the windscreen in any suitable manner. Indicia 106 are displayed on the display screen of the screen body 102 and are reflected off of the reflective member 104. The base body 108 has a front side (not shown in FIG. 1) and a back side 109. The screen body 102 in FIG. 1 is depicted adjacent the front side of the base body 108. The screen body 102 is coupled by the base body 108 by a hinge 110 or other coupling arrangement at the top portion of the base body 108 or another coupling arrangement. The hinge 110 may be any type of suitable coupling arrangement 110 and may include any suitable dimensions. The hinge 110 is configured to allow pivotal movement of the screen body 102 with respect to the base body 108 along a first orientation. A pivot member 112 is coupled to the lower portion of the base body 108. The pivot member 112 is configured to allow pivotal movement of the base body 108 along a second orientation. The pivot member 112 can attach to a surface in any number of manners, including by velcro tape, screws, or any suitable hardware.

As mentioned, the hinge 110 is configured to allow pivotal movement of the screen body with respect to the base body 108 along a first orientation. The pivot member 112 is configured to allow pivotal movement of the base body 108 along a second orientation. The movement along either the first orientation or the second orientation may be made manually by a user moving the device components, by a remote control mechanism where the device components are moved by, for example, a motor, or automatically where sensors of the device can determine ambient conditions and change the orientation of the screen body 102 to optimize the display output of the device.

While the display form factor device is described with reference to a use case involving a vehicle, it is understood that a device having the display form factor could be utilized in any number of types of devices. For example, the display form factor could be used to share information with others. For example, the display form factor could be used as a picture viewer, or in a commercial setting such as at a cash register to exhibit information.

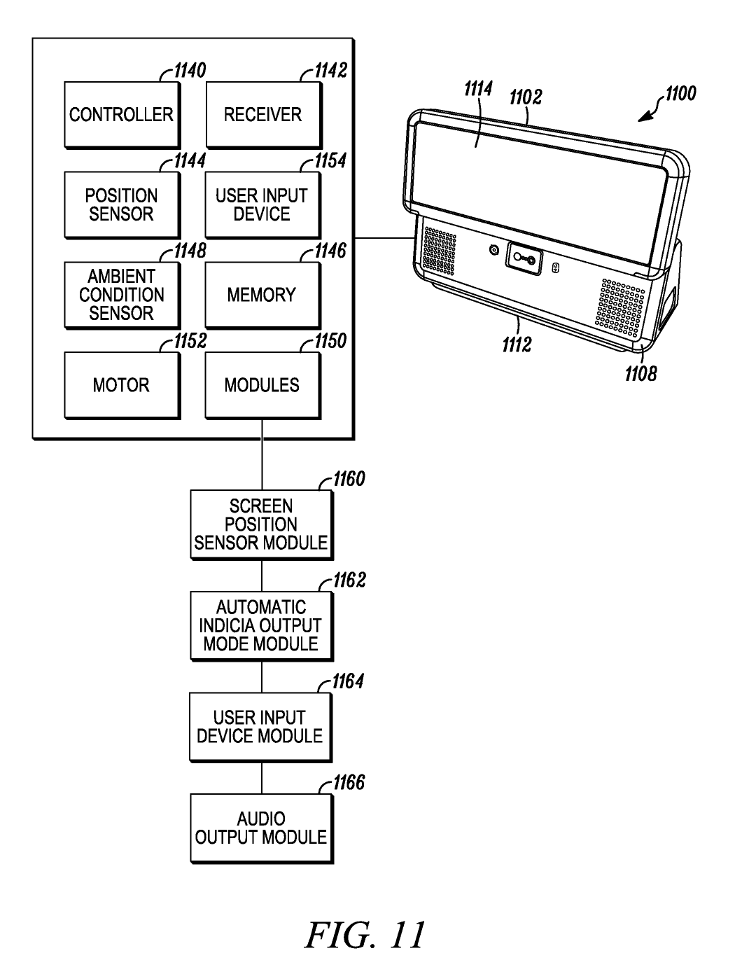

Exhibition of the indicia 106 can be provided in a plurality of manners. The display form factor device 100 may provide its own navigation circuitry, the controls of which are not shown. The device 100 may otherwise receive information via from another source, for example, a mobile communication device, to process and exhibit on the display screen. The processing, as will be discussed in more detail below. The information can be for example, graphic data, text data, audio data, ambient conditions data. Audio output may be provided by one or more audio output devices 113-A and 113-B in accordance with an audio output module 1166 (see FIG. 11 below).

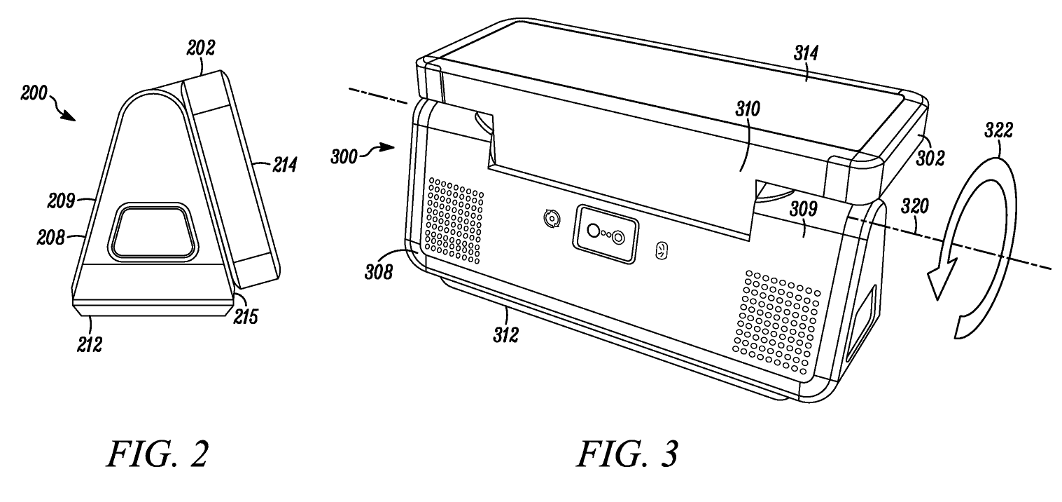

FIG. 2 illustrates a side perspective view of an embodiment of a display form factor 200. The screen body 202 supports the display screen 214. The screen body 202 is coupled to the upper portion of the base body 208. The pivot member 212 is coupled to the lower portion of the base body 212. The position of the screen body 202 with respect to the base body 208 is similar to that of FIG. 1. In this figure, the display screen 214 is depicted as available for viewing from the front side 215 of the base body 208. In another arrangement discussed below, the display screen 214 can be moved so that viewing of the display screen 214 is viewable from the back side 209 of the base body 208.

FIG. 3 illustrates a perspective view of an embodiment of a display form factor 300 similar to the view of FIG. 1. The screen body 302 which supports the display screen 314 is in a raised position with respect to the base body 308 to depict that the hinge member 310 is movably coupled screen body 302 and the base body 308. The raised position of the screen body 302 is one of a plurality of positions that the screen body 302 can assume with respect to the base body 308 along the first orientation 320. In this example, the first orientation 320 is a horizontal orientation. The hinge member 310 can allow rotation 322 about the first orientation 320 to allow the screen body 302 to assume one of a plurality of positions with respect to the base body 310.

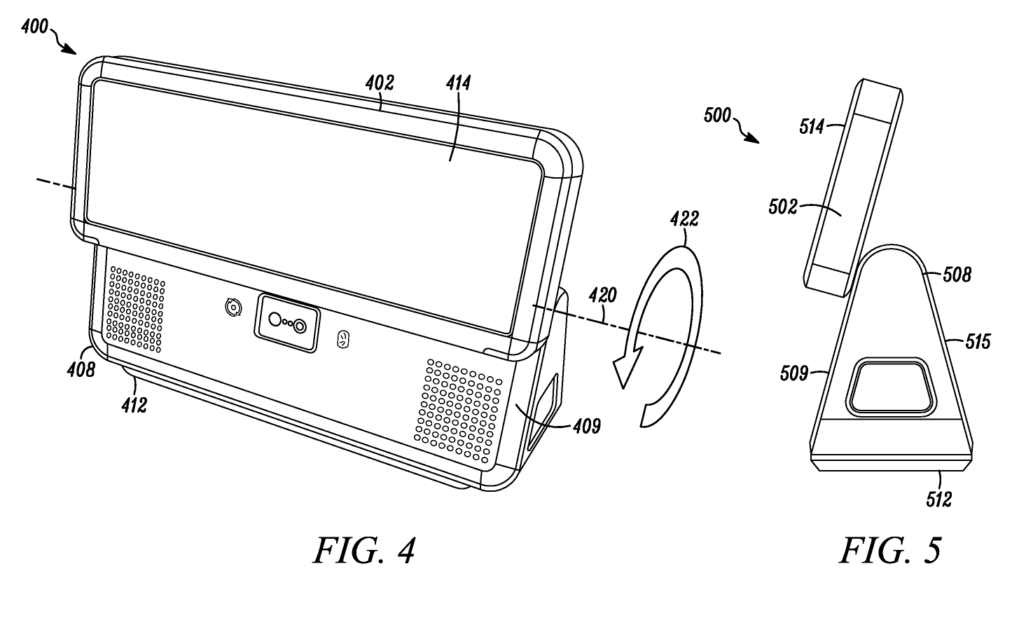

FIG. 4 illustrates a perspective view of an embodiment of a display form factor 400 also similar to the view of FIG. 1. The screen body 402 is in another position with respect to the base body 408 more than that shown in FIG. 3 to depict that the hinge member 410 is movably coupled screen body 402 and the base body 408. The position of the screen body 402 is another one of a plurality of positions that the screen body 402 can assume with respect to the base body 408 along the first orientation 420 and in particular a viewing position. In this example, the first orientation 420 is a horizontal orientation. The hinge member 410 can allow rotation 422 about the first orientation 420 to allow the screen body 402 to assume on of a plurality of positions with respect to the base body 408, in this example adjacent the back side 409 of the base body 408. As will be discussed below, indicia 106 (see FIG. 1) may be exhibited on the display screen 414 in different orientations dependent upon which of the plurality of positions is assumed by the screen body 402.

FIG. 5 illustrates a side perspective of an embodiment of a display form factor 500. The screen body 502 supports the display screen 514 and is shown in a position similar to that shown in FIG. 4. The screen body 502 is coupled to the base body 508 which as discussed above has a back side 509 and a front side 515. The pivot member 512 is coupled to the lower portion of the base body 512 and allows pivotal movement of the base body 508 along a second orientation as will be discussed below.

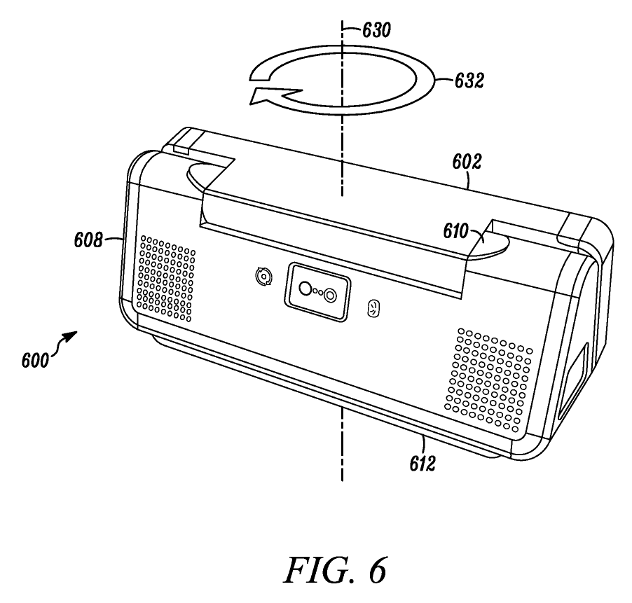

FIG. 6 illustrates a perspective view of an embodiment of a display form factor 600 similar to the view of FIG. 1. The screen body 602 is coupled to the base body 608 by the hinge member 610. The base body 608 can assume a plurality of positions with respect to the pivot member 612 along a second orientation 630. In this example, the second orientation 630 is a vertical orientation. The pivot member 612 can allow rotation 632 about the second orientation 630 to allow the screen body 602 to assume one of a plurality of positions with respect to the pivot member 612.

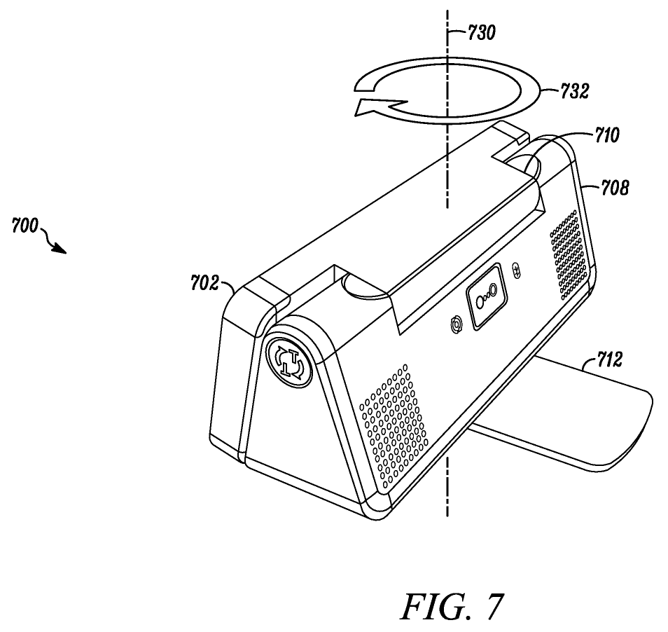

FIG. 7 illustrates another perspective view of an embodiment of a display form factor 700. The screen body 702 which is coupled to the base body 708 by the hinge member 710 is in the same position as shown in FIGS. 1, 2 and 6. As discussed, the base body 708 can assume a plurality of positions with respect to the pivot member 712 along a second orientation 730. As depicted, the pivot member 712 can allow rotation 732 about the second orientation 730 to allow the screen body 702 to assume one of a plurality of positions with respect to the pivot member 712.

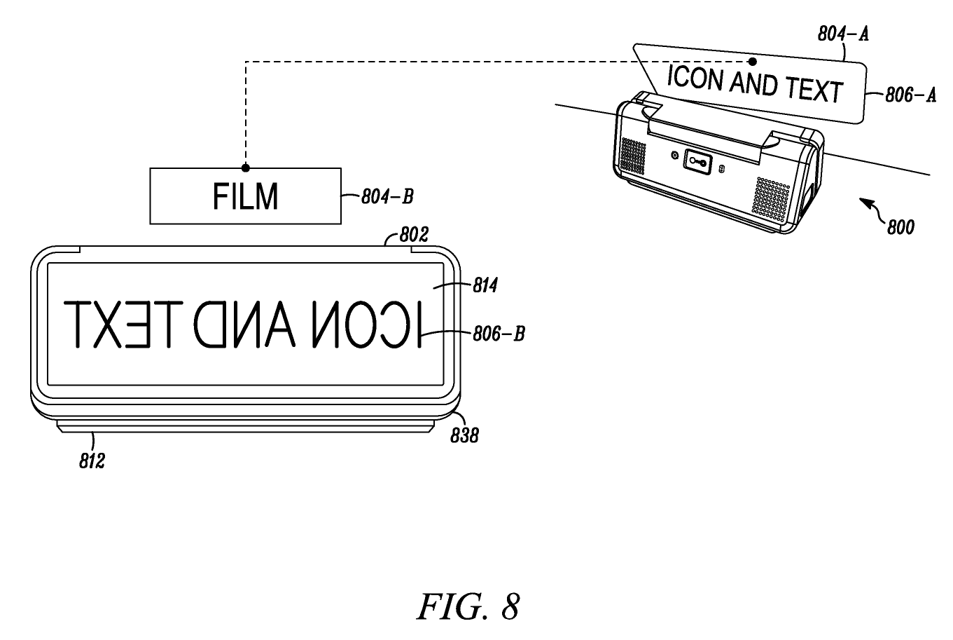

FIG. 8 illustrates indicia in a reflective mode that is transposed to normal mode upon reflection by a reflective film. FIG. 8 depicts a front view of an embodiment of a display form factor device where the screen body has assumed the same position as that shown in FIG. 2. FIG. 8 further depicts an embodiment of the display form factor 800 screen body 802 in the same position as that shown in FIG. 1 as well as the film 804-A with indicia 806-A indicated by “icon & text” that is reflected thereon. The figure shows a front view of the display screen 814 with, at a slightly tilt 838 as illustrated in FIG. 2 indicating the same indicia 806-B in a reflective particular orientation, that when reflected in the reflective film 804-B, is transposed so that it can be normally read as indicated by indicia 806-A on film 804-B. The shape of the example base member 804 provides a tilt 838 so that the display screen 814 can project the indicia 806-B in the direction of the film 804-B. The pivot member 812 may also include an angle providing device such as a foot or pad that can raise the display form factor 800 farther, or otherwise change tilt of the base body 808.

As discussed above, the display form factor 800 can assume a plurality of positions with respect to two orientations, the first orientation 320 (see FIG. 3) and the second orientation 632 (see FIG. 6). It is understood that the display form factor 800 can be manipulated to assume a position with respect to either one of the orientations, or both of the orientations. The exhibition of the indicia has a particular orientation, in this example, a reflective particular orientation 806-B. That is, the indicia 806-B is reversed so that when it is shown upon a reflective film 804-A, it is shown normally. The particular orientation of the indicia is dependent upon which of the at least one of a plurality of positions is assumed by the screen body 802 with respect to the base body 808 and the pivot member 812, and can be automatically adjusted.

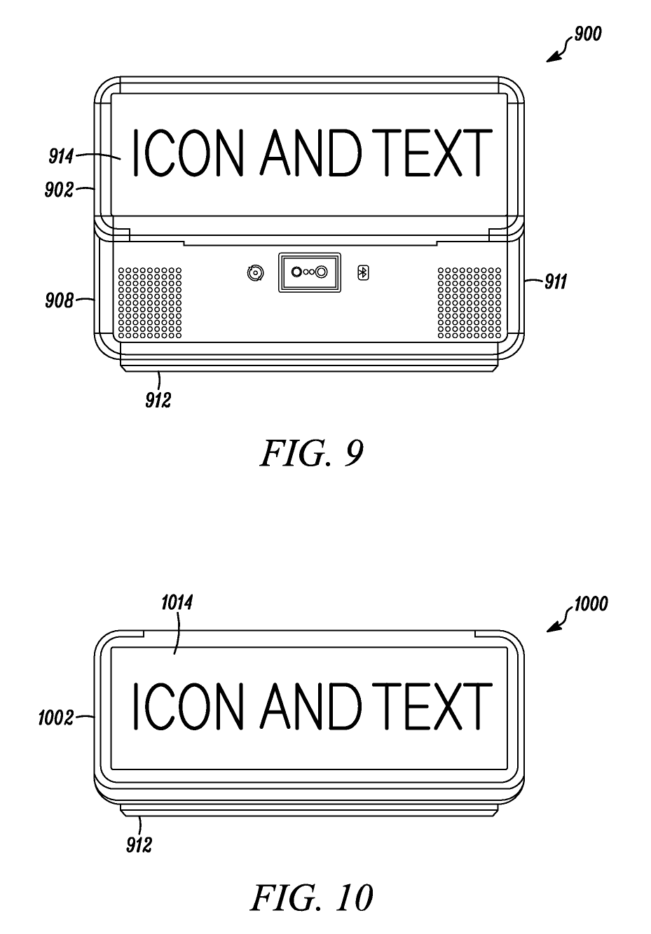

FIG. 9 illustrates a front view of an embodiment of a display form factor device 900 where the screen body 902 has assumed the same position as that shown in FIG. 5. As mentioned above, the display screen 914 is available for viewing from the back side 911 of the base body 908. The particular orientation of the indicia 914 is as it would be normally read.

FIG. 10 illustrates a view of the display screen 1002 of an embodiment of a display form factor device in a position such as that shown in FIGS. 2 and 8, where the display screen 1014 of the screen body 1002 is viewable from the front side of the base body 908 (see FIG. 9). As in FIG. 9, the particular orientation of the indicia 914 is the as it would be normally read which is different from the reflective particular orientation of the indicia 814 shown in FIG. 8, even though the position of the screen body is the same in both FIG. 8 and FIG. 10.

FIG. 11 illustrates a perspective view of an embodiment of the display form factor device 1100 including electronic components. The device can include a controller 1140, a receiver 1142, a sensor 1144, a memory 1146 that may store instruction modules 1150. The instruction modules 1150 can include modules such as screen position sensor module 1160, an automatic indicia output mode module 1162, a user input device module 1164 and an audio output module 1166. The modules can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

The controller or processor 1140 is configured to process information to display the exhibited indicia by the display screen 1114. As discussed above, the information may be received via receiver 1142 that may be for example, a Bluetooth receiver or a Global Positioning System (GPS) receiver. The exhibited indicia may be internally generated, or may be generated by another device, such as a mobile communication device in communication with a source of information.

The controller 1140 can be further configured to receive sensor input such as that of position sensor input 1144 to automatically change the mode of the indicia output on the display screen 1114 based on the position of the screen body. As mentioned, the hinge 110 (see FIG. 1) is configured to allow pivotal movement of the screen body 1102 with respect to the base body 1108 along a first orientation, such as the horizontal orientation (see FIGS. 3 and 4). The pivot member 1112 is configured to allow pivotal movement of the base body 1108 along a second orientation (see FIGS. 6 and 7). The movement along either the first orientation or the second orientation may be made manually by a user moving the device components. For example, if a user were to manually move the screen body 1114 from a first position to a second position, the particular orientation of the indicia may be automatically configured to be output in a reflective mode or output in a normal reading mode. A position sensor 1144 can sense the position of the device components, that is, the position of the screen body 1102 with respect to the base body 1108 and/or the pivot member 1112. Moreover, the position of the display form factor device 1100 may be calibrated to the vision of the user, for example, in the driver's seat of a vehicle. In any case, the screen position sensor module 1160 can process position sensor data provided by the position sensor 1114 and so the mode of the indicia may be automatically changed in accordance, for example with the automatic indicia output mode module 1162.

Also, an ambient condition sensor 1148 can be configured to determine ambient conditions and generate ambient condition data. For example, the ambient sensor 1148 may detect changing lighting conditions. The controller 1140 can process the ambient condition data to initiate change of the position of the screen body with respect to at least one of the base body and pivot member based ambient condition data. A motor 1152 in the device may automatically move the display body 1102 from a first position (see FIG. 2) to a second position (see FIG. 5) to make accommodations for the ambient lighting conditions. Accordingly, at least one of the hinge 110 (see FIG. 1) and the pivot member 112 can be configured for automated adjustment. The particular orientation of exhibited indicia is determined as well (for example, see FIGS. 8 and 9). Additionally, the automatic indicia output mode module 1162 can provide instructions that can in addition or in the alternative, change the contrast or any other output characteristic of the indicia on the display screen to optimize the display screen 1114 output based on ambient conditions sensed by the ambient condition sensor 1148.

As discussed above, the position of the screen body 1102 may be manually arranged with respect to the base body 1108 and/or the pivot member 1112. Alternatively a user input device 1154 may be operated in accordance with a user input device module 1164 by a remote control mechanism where the device components are moved by, for example, a motor 1152. A motor 1152 in the device may move the display body 1102 from a first position (see FIG. 2) to a second position (see FIG. 5) based on instructions from the user input device module 1164. Accordingly, at least one of the hinge 110 (see FIG. 1) and the pivot member 112 can be configured for motorized adjustment.

The same or a different user input device 1154 (for simplicity a single device 1154 is shown, however, it is understood that different user input functions may be provided by discreet devices), may be used to change the particular orientation or other characteristic of exhibited indicia in accordance with a user input device module 1164. A user may the position of the display body 1102 with respect to the base body 1108. That chosen position may automatically provide a particular orientation. However, the user may manually change the orientation or other characteristic of exhibited indicia from a default orientation to a chosen orientation. In this way, the device 1102 may be useful for many different use cases as mentioned above.

Disclosed are methods of a device having a display form factor device having a first orientation and a second orientation. The first orientation is for example, a horizontal orientation. The second orientation is for example, a vertical orientation. The display form factor device includes a base body and a screen body. The base body further has a top portion and a lower portion wherein the screen body is coupled to the base body at the top portion of the base body. A hinge movably couples the screen body to the base body, the hinge configured to allow pivotal movement of the screen body with respect to the base body along the first orientation. The display form factor further includes a pivot member movably coupled to the lower portion of the base body, the pivot member configured to allow pivotal movement of the base member along the second orientation. A display screen is supported by the screen body, the screen body being configured to assume at least one of a plurality of positions with respect to the base body and the pivot member along the first orientation and the second orientation. The display screen is configured to exhibit indicia having a particular orientation thereon, wherein the indicia having a particular orientation is dependent upon which of the at least one of a plurality of positions with respect to the base body and the pivot member that is assumed by the screen body. Accordingly, when adjusting the position of screen body to one of a plurality of positions, a method of the device includes changing the mode of exhibiting indicia based upon the position of the screen body. Ambient conditions, such as ambient lighting, may make viewing from one particular orientation better than another particular orientation. In this way, beneficially the display screen of the display form factor device can be manipulated so that it may be viewed from many different orientations and the indicia displayed thereon will accommodate the screen viewing position.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A display form factor device, comprising:
a base body having a first orientation and a second orientation, the base body further having a top portion and a lower portion;
a screen body coupled to the base body at the top portion of the base body;
a hinge movably coupling the screen body to the base body, the hinge configured to allow pivotal movement of the screen body with respect to the base body along the first orientation;
a pivot member movably coupled to the lower portion of the base body, the pivot member configured to allow pivotal movement of the base body along the second orientation; and
a display screen supported by the screen body, the screen body being configured to assume at least one of a plurality of positions with respect to at least one of the base body and the pivot member along at least one of the first orientation and the second orientation, the display screen configured to exhibit indicia having a particular orientation thereon, wherein the indicia having a particular orientation is dependent upon which of the at least one of a plurality of positions with respect to the base body and the pivot member is assumed by the screen body.

2. The display form factor device of claim 1 wherein base body has a front side and a back side, wherein the hinge is configured to allow pivotal movement of the screen body with respect to the base body along the first orientation provides that the display screen supported by the screen body is configured for viewing from either the front side of the base body and from the back side of the base body.

3. The display form factor device of claim 1, wherein the pivot member is attachable to a surface.

4. The display form factor device of claim 1 wherein the first orientation is along a horizontal axis with respect to the pivot member.

5. The display form factor device of claim 1 wherein the second orientation is along a vertical axis with respect to the pivot member.

6. The display form factor device of claim 1 wherein at least one of the hinge and the pivot member are configured for manual adjustment.

7. The display form factor device of claim 1 wherein at least one of the hinge and the pivot member are configured for automated adjustment.

8. The display form factor device of claim 1 further comprising at least one position sensor configured to generate position sensor data, the at least one sensor further configured to determine the position of the screen body with respect to at least one of the base body and pivot member wherein the particular orientation of exhibited indicia is determined based on position sensor data.

9. The display form factor device of claim 1 further comprising:
an ambient condition sensor configured to determine ambient conditions and generate ambient condition data; and
a controller to process the ambient condition data, the controller further configured to determine the position of the screen body with respect to at least one of the base body and pivot member so that the particular orientation of exhibited indicia is determined based ambient condition data.

10. The display form factor device of claim 1 further comprising a user input device to change the particular orientation of exhibited indicia.

11. The display form factor device of claim 1 further comprising at least one receiver for receiving information.

12. The display form factor device of claim 11 further comprising:
a controller configured to process information to display the exhibited indicia by the display screen.

13. The display form factor device of claim 11 further comprising:
an audio output device to output audio signals; and
a controller configured to process information based to generate audio output by the audio output device.

14. A system for a display form factor device, comprising:
a base body having a first orientation and a second orientation, the base body further having a top portion and a lower portion;
a screen body coupled to the base body at the top portion of the base body;
a hinge movably coupling the screen body to the base body, the hinge configured to allow pivotal movement of the screen body with respect to the base body along the first orientation;
a pivot member movably coupled to the lower portion of the base body, the pivot member configured to allow pivotal movement of the base member along the second orientation;
a reflective member position proximally to the screen body; and
a display screen supported by the screen body, the screen body being configured to assume at least one of a plurality of positions with respect to at least one of the base body and the pivot member along at least one of the first orientation and the second orientation, the display screen configured to exhibit indicia having a particular orientation thereon so that the indicia having a particular orientation is reflected by the reflective member so that the indicia is viewed in a standard orientation by the reflective member.

15. The display form factor of claim 14, wherein the pivot member is attachable to a first surface.

16. The display form factor of claim 14, wherein the reflective member is attachable to a second surface.

17. The display form factor device of claim 1 further comprising:
at least one receiver for receiving information; and
a controller configured to process information to exhibit indicia by the display screen.

18. The method of a display form factor device, wherein the device comprises a base body having a first orientation and a second orientation, the base body further having a top portion and a lower portion, a screen body coupled to the base body at the top portion of the base body, a hinge movably coupling the screen body to the base body, the hinge configured to allow pivotal movement of the screen body with respect to the base body along the first orientation, a pivot member movably coupled to the lower portion of the base body, the pivot member configured to allow pivotal movement of the base member along the second orientation, and a display screen supported by the screen body, the screen body being configured to assume at least one of a plurality of positions with respect to at least one of the base body and the pivot member along at least one of the first orientation and the second orientation, the display screen configured to exhibit indicia having a particular orientation thereon, wherein the indicia having a particular orientation is dependent upon which of the at least one of a plurality of positions with respect to the base body and the pivot member is assumed by the screen body, the method comprising:
adjusting the position of screen body to one of the plurality of positions; and
changing the mode of exhibiting indicia based upon the position of the screen body.

19. The method of claim 18 wherein changing the mode of exhibiting indicia based upon the position of the screen body further comprises automatically changing the mode of the exhibited indicia dependent upon ambient condition data received from an ambient condition sensor.

20. The method of claim 18 wherein changing the mode of exhibiting indicia based upon the position of the screen body further comprises manually changing the mode of the exhibited indicia dependent upon user input.
